(19) United States
(12) Patent Application Publication
(10) Pub. No.: US 2010/0241468 A1
(43) Pub. Date: Sep. 23, 2010

(54) System and method for measuring social capital index in an online social network

(75) Inventor: Yu-Sok Yang, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: O WAVE MEDIA Co., Ltd.

(21) Appl. No.: 12/385,530

(22) Filed: Apr. 10, 2009

(30) Foreign Application Priority Data
Mar. 20, 2009 (KR) 10-2009-0024131

(51) Int. Cl. G06Q 10/00; G06F 17/30

(52) U.S. Cl. 705/7; 707/E17.044

(57) ABSTRACT

A system and method for measuring social capital index in an online social network has developed to measure competitive power, coherence, etc. with social capital index by a plurality of element (trust, integrity, solidarity, openness, importance, intimacy) towards specific network with each individual, and the whole network; to set up standards of route search in the social network map (GUI which expresses the social connection network as a graphic map); perform innovative services with obtaining asymmetric information of the link, the object of network analysis of the social connection network, and to establish a stable network.

### BACKGROUND OF THE INVENTION

1. Field of the Invention

The present invention relates to a system and method for measuring social capital index in an online social network, and more particularly, the system and method wherein the social capital index of each member is measured by inter-evaluation while members of Social Networking Service (SNS) establish and exchange human connection with various kinds of members.

2. Related Prior Art

The Internet influencing our normal life has been overwhelmingly changed. For instance, online social networks have functioned as a new foundation of meetings. These have been called as a new power lunch table and a new golf course for business in America. Further, many people have recombined their friends, neighborhoods, communities, and societies into themselves by using online social networks.

Influencing most parts of our normal life, such online social networks helps to directly connect to other people who have similar ways of thinking and to form a partnership with more people by much more ways than ever.

While diverse social networking services are currently provided, membership is classified into invitation types and openness types and joining membership is available for everyone because openness is mostly selected. Accordingly, the quality of members has fallen off. Also, major problems have been occurred in relation to truth and trust of networks by the structure in which the social connection network is expanded by approvals of requests for simple online friends.

For example, as for “MYSPACE”, the famous social networking service in America, approximately 7,000 databases of doubtful members were deleted by matching databases of suspected criminals in 2007, and 90,000 sex criminals lost their membership privilege in 2009. As for “www.fakemyspace.com”, it comes to social attention that problems related to truth and trust of networks are generated because pay services for expanding friends in response to demand of members are provided, and it is not possible that innovative services are provided by analyzing a network link because links of all networks of social networking services are constituted with symmetric information (simple friends).

The present invention is directed to solving above problems, and the object of the invention is to provide the method and system for measuring social capital index in an online social network, enabling to index and measure social capital which indicates competitive power among individuals by inter-evaluation performed among the first human network after members of the social networking services establish the first human connection by requesting and approving agreement of human relationship, and to create a basis for providing innovative services with network analysis by obtaining asymmetric information constituting a link between nodes of the social connection network.

### SUMMARY OF THE INVENTION

The present invention to accomplish the above objects is characterized by comprising: a social network database to which personal information of a member, member ID in the human relation based on the social network, the member ID, and the member ID of the first human connection are stored; and individual item index using each valuation score, inputted through the valuation item fill-out applet, after providing the valuation item fill-out applet for measuring the social capital index with each member of the first human connection when the valuation service is selected and an application server measuring the social capital index among first human connections and storing them in the social network database.

Here, the social network database is comprised of member information database to which each member's personal information including ID, name(s), email address(es), telephone number(s), job(s), work area(s), address(es), nation, and school(s) is stored; and human network database storing valuation scores, individual item index, and social capital index among the first human relation with member ID as a key while member ID and the member ID of the first human relation are respectively stored in order to check the member ID that is in the first human relation with members on a basis of social network.

Further, the valuation item fill-out applet is provided as a type of graphic user interface (GUI) in the application server.

At this time, each of trust index, integrity index, solidarity index, openness index, importance index, and intimacy index of the valuation item fill-out applet is supplied as valuation items, and a check box is provided in order to record the valuation score, which is upgraded from the lowest value step by step, in each valuation item.

Desirably, in the application server, when the valuation score is checked among the first human relation through the valuation item fill-out applet, the valuation score is changed to the individual item index, and the social capital index is measured after giving weight value to the individual item index again.

More desirably, the weight value is differently applied depending on trust index, integrity index, solidarity index, openness index, importance index, and intimacy index, and the different applied grand total is 100%.

Meanwhile, the valuation score, the individual item index, and social capital index in the application server is separately stored in the human network information database of the social network database.

Further, in the application server, in case that one of members, or both members of the first human network do not perform the valuation service, either the valuation score of one of members or one of both members of the first human network is recorded to the lowest value.

Here, the application server is provided with revaluation service so that a member can correct the social capital index of the first human network; the application service is provided with the valuation item applet when the revaluation service is selected; and the individual item index and the social capital index of the first human network are renewed and stored in the human network database of the social network database after measuring the individual item index and the social capital index of the first human network by using each valuation score checked by the valuation item applet.

In addition, in the application server, the whole social capital index toward all or partial social connection networks is measured by using the individual item index and the social capital index stored in the human network information database of the social network database.

Furthermore, the method for measuring social capital index in an online social network of the present invention is characterized by comprising processes of: establishing first human network wherein the first human network is established after logging in on the homepage of the application server; providing valuation service wherein the valuation service is provided in order to inter-evaluate the social capital index of the first human network in the application server when the first human network is established; providing applets wherein the valuation item fill-out applet for measuring the social capital index in the application server to each member of the first human network when the valuation service is selected by members; and measuring the social capital index wherein the individual item index and the social capital index of the first human network are stored in the social network database after measuring the individual item index and the social capital index of the first human network by using each valuation score in the application server when each valuation score is inputted by the valuation item fill-out applet.

Here, the valuation item fill-out applet is provided as a type of graphic user interface (GUI) in the process of providing applets.

At this time, each of trust index, integrity index, solidarity index, openness index, importance index, and intimacy index of the valuation item fill-out applet is supplied as valuation items, and a check box is provided in order to record valuation scores, which is upgraded from the lowest value step by step, in each valuation item.

Desirably, in the process of providing applets, when the valuation score is checked among the first human relation through the valuation item fill-out applet, the valuation score is changed to the individual item index, and the social capital index is measured after giving weight value to the individual item index again.

More desirably, the weight value is differently applied depending on trust index, integrity index, solidarity index, openness index, importance index, and intimacy index, and the different applied grand total is 100%.

Further, in the process of measuring the social capital index, in case that one of members, or both members of the first human network does not perform the valuation service, either the valuation score of one of members or one of both members of the first human network is recorded to the lowest value.

Meanwhile, the method for measuring the social capital index in the online social network further comprises the process of renewing the social capital index wherein revaluation service is provided so that a member can correct the social capital index of the first human network, and the individual item index and the social capital index of the first human network are renewed and stored in human network database of the social network database after measuring the individual item index and the social capital index of the first human network by using each valuation score checked by the valuation item applet.

Furthermore, the method for measuring the social capital index in the online social network further comprises the process of measuring the whole social capital index wherein the whole social capital index toward the whole or partial social connection networks is measured by using the individual item index and the social capital index stored in the human network information database of the social network database.

According to the method and system for measuring social capital index in an online social network, constituted as above, the effects of the present invention are to measure competitive power, coherence, etc. with social capital index by a plurality of element (trust, integrity, solidarity, openness, importance, intimacy) towards specific network with each individual, and the whole network; set up standards of route search in the social network map (GUI which expresses the social connection network as a graphic map); perform innovative services with obtaining asymmetric information of the link, the object of network analysis of the social connection network, and establish a stable network.

### BRIEF DESCRIPTION OF THE DRAWINGS

FIG. 1 is a schematic diagram representing the constitution of the system for measuring social capital index in a social network according to the present invention;

FIG. 2 is a drawing representing an example of valuation item fill-out applets from an application server in the system for measuring social capital index in the social network according to the present invention;

FIG. 3 is a drawing representing weight value, valuation scores, individual item index, and social capital index in accordance with each valuation item after members of A and B finish describing index under condition that both are in the first human connection according to the present invention;

FIG. 4 is a drawing representing the status in which the lowest value automatically given from the system is reflected when one member delays assessment for a valuation item for measuring social capital index among the first human connection according to the present invention;

FIG. 5 is a diagram representing the status in which the lowest value automatically given from the system is reflected when assessment for a valuation item for measuring social capital index among the first human connection is delayed among members according to the present invention;

FIGS. 6 and 7 are action flow diagrams for explaining the method for measuring social capital index in the social network according to the present invention; and

FIG. 8 is a diagram representing a social network map for explaining the method for measuring social capital index in the social network according to the present invention.

### DETAILED DESCRIPTION OF THE PREFERRED EMBODIMENTS

Hereinafter, an explanation of a structure of the system for measuring social capital index in an online social network according to the present invention will be given with reference to the attached drawings.

A detailed explanation on the known functions and configurations related to this invention will be avoided for the brevity of the description. And, the terms as will be mentioned below are used by the functions defined in this invention, which is of course varied in accordance with the intension or rules of a user or operator. Therefore, the definition of the terms should be based upon the contents of the description of the invention.

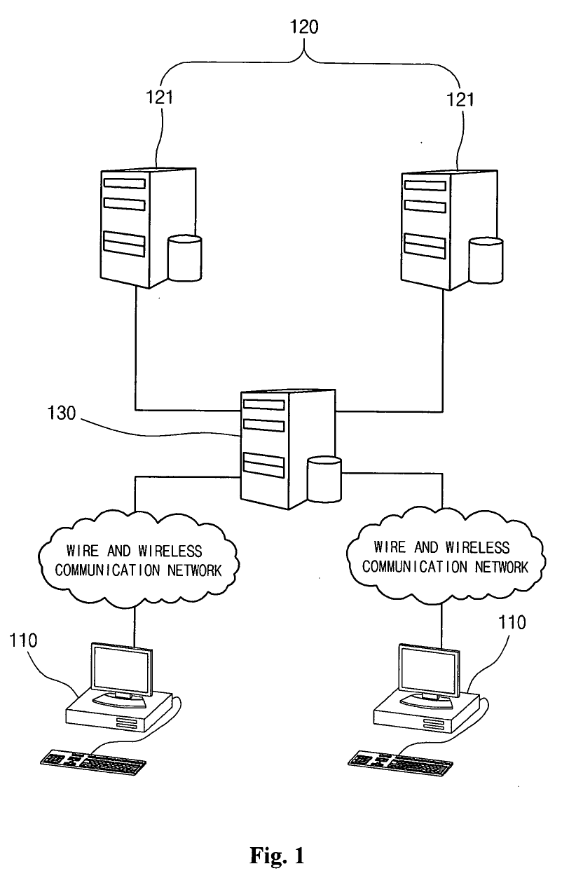

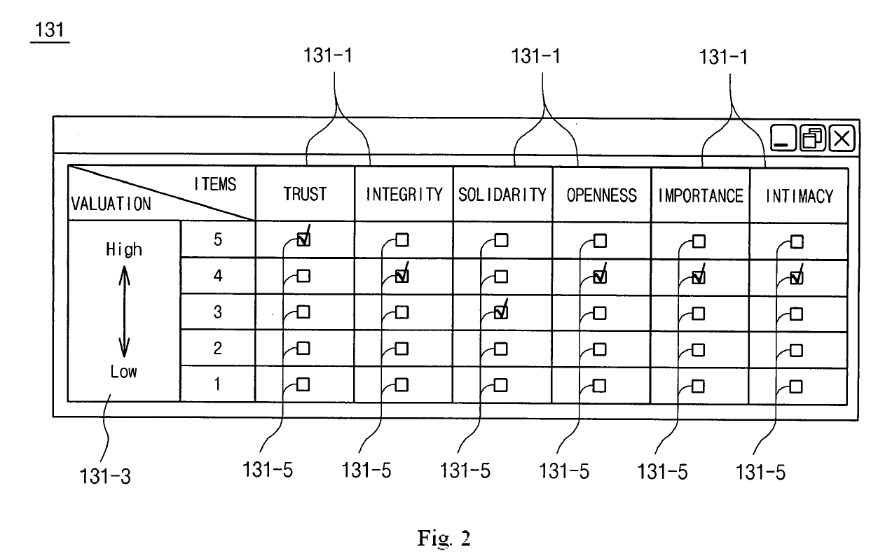

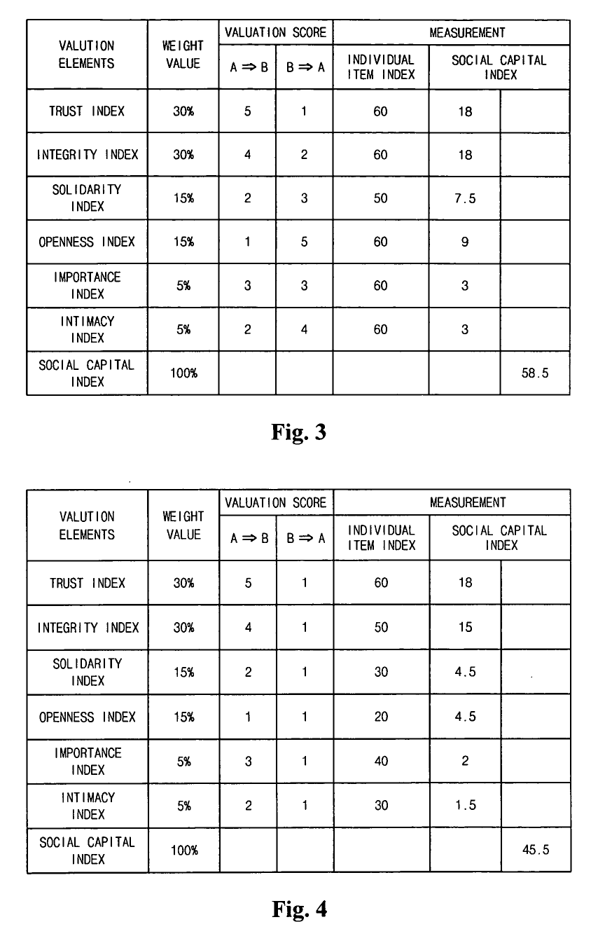

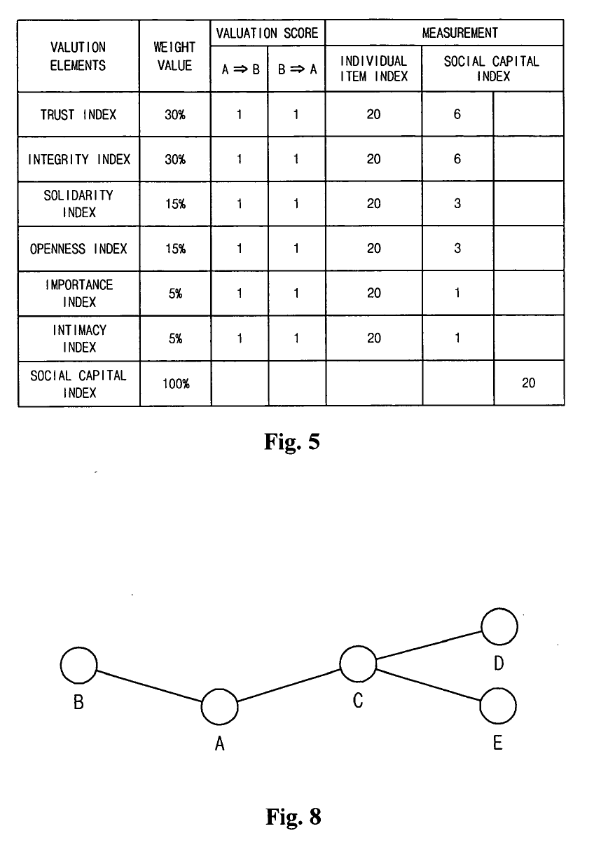

FIG. 1 is a schematic diagram representing the constitution of the system for measuring social capital index in a social network according to the present invention; FIG. 2 is a drawing representing an example of valuation item fill-out applets from an application server in the system for measuring social capital index in the social network according to the present invention; FIG. 3 is a drawing representing weight value, valuation scores, individual item index, and social capital index in accordance with each valuation item after members of A and B finish describing index under condition that both are in the first human connection according to the present invention; FIG. 4 is a drawing representing the status in which the lowest value automatically given from the system is reflected when one member delays assessment for a valuation item for measuring social capital index among the first human connection according to the present invention; and FIG. 5 is a diagram representing the status in which the lowest value automatically given from the system is reflected when assessment for a valuation item for measuring social capital index among the first human connection is delayed among members according to the present invention.

Explaining terms and roles used in the present invention, social capital index (SCI) indicates value of social capital which is indexed by trust, integrity, solidarity, openness, importance, and intimacy; trust index (TI) indicates the will and capability to keep one's promise; integrity index (II) indicates the will and capability to follow principles; solidarity index (SI) indicates the will and capability for solidarity; openness index indicates the will and capability for openness; importance index (imI) indicates importance of relationship; and intimacy index (inI) indicates intimacy of relationship.

Referring to FIGS. 1 to 5, the system for measuring social capital index in an online social network (100) according to the present invention consists of a client computer (110), social network database (120), and an application server (130).

First, the client computer (110) indicates a terminal which enables a member to connect to the homepage of the application server (130) to be explained through wire and wireless communication network as below, comprising a desk top, a lap top, a portable multimedia player(PMP), palm top, etc.

Further, the social network database is comprised of member information database to which each member's personal information including ID, name(s), email address(es), telephone number(s), job(s), work area(s), address(es), nation, and school(s) is stored; and human network database storing valuation scores, individual item index, and social capital index among the first human relation with member ID as a key while member ID and the member ID of the first human relation are respectively stored in order to check the member ID that is in the first human relation with members on a basis of social network.

Furthermore, the application server (130) indicates a server which controls the whole system, particularly wherein the valuation service which enables to inter-evaluate the social capital index for the first human relation is provided when connecting to a homepage through wire and wireless Internet network by using the client computer (110), members log in; and the valuation score, the individual item index, and the social capital index are stored in the human network information database (123) of the social network database (120) after measuring the individual item index and the social capital index of the first human connection by using each valuation score, inputted by the valuation item fill-out applet (131), after supplying the valuation item fill-out applet (131) for measuring the social capital index to each member of the first human relation when the valuation service is selected.

Here, in the application server (130), the individual item index and the social capital index are separately stored in the human network information database (122) of the social network database (120) in order to measure the whole social capital index toward all or partial social connection networks.

At this time, as illustrated in FIG. 2, the valuation item fill-out applet (131) is provided as a type of graphic user interface (GUI); each of trust index, integrity index, solidarity index, openness index, importance index, and intimacy index is supplied as valuation items (131-1); and the check box (131-5) is provided in order to record valuation scores (131-3), which is upgraded from the lowest value step by step, in each valuation item. In the present invention, valuation scores (131-3) is classified into 1 to 5 scores, and these can be further specified or reduced depending on choice.

In the application server (130), when the valuation score is checked among the first human relation through the valuation item fill-out applet (131), the valuation score is changed to the individual item index, and the social capital index is measured after giving weight value to the individual item index again. The weight value is differently applied depending on trust index, integrity index, solidarity index, openness index, importance index, and intimacy index, and the different applied grand total is 100%.

Here, it is desirable to measure the individual item index with the value generated from multiplication of 10 and the added value of valuation scores of members of A and B in order to maintain the index value at tens upon measuring the social capital index, and it is possible to change this manner to any types.

In addition, the total of given weight value is set to 100% by giving trust index and integrity index, solidarity index and openness index, importance index and intimacy index 30%, 30%, and 5%, respectively, and weight values can be changed depending on selection.

That is, as illustrated in FIG. 3, if member A gives valuation score of 5 points to trust index of member B, and member B gives valuation score of 1 point to trust index of member A, the individual item index scores 60 points by multiplying 10 and the total of 5 points and 1 point, and the social capital index according to items scores 18 points by multiplying 60 points and weight value of 30%, i.e., 0.3.

In addition, if member A gives valuation score of 4 points to integrity index of member B, and member B gives valuation score of 2 points to integrity index of member A, the individual item index scores 60 points by multiplying 10 and the total of 4 points and 2 points, and the social capital index according to items scores 18 points by multiplying 60 points and weight value of 30%, i.e., 0.3.

Further, if member A gives valuation score of 2 points to solidarity index of member B, and member B gives valuation score of 3 points to solidarity index of member A, the individual item index scores 50 points by multiplying 10 and the total of 2 points and 3 points, and the social capital index according to items scores 7.5 points by multiplying 50 points and weight value of 15%, i.e., 0.15.

Further, if member A gives valuation score of 1 point to openness index of member B, and member B gives valuation score of 5 points to openness index of member A, the individual item index scores 60 points by multiplying 10 and the total of 1 point and 5 points, and the social capital index according to items scores 9 points by multiplying 60 points and weight value of 15%, i.e., 0.15.

Further, if member A gives valuation score of 3 points to importance index of member B, and member B gives valuation score of 3 points to importance index of member A, the individual item index scores 60 points by multiplying 10 and the total of 3 points and 3 points, and the social capital index according to items scores 3 points by multiplying 60 points and weight value of 5%, i.e., 0.05.

Further, if member A gives valuation score of 2 points to intimacy index of member B, and member B gives valuation score of 4 points to importance index of member A, the individual item index scores 60 points by multiplying 10 and the total of 2 points and 4 points, and the social capital index according to items scores 3 points by multiplying 60 points and weight value of 5%, i.e., 0.05.

Furthermore, the social capital index indicate the added value of all social capital indexes of each item, i.e., 58.5 points of the total of 18 points, 18 points, 7.5 points, 9 points, 3 points, and 3 points.

In the application server (130), as illustrated in FIG. 4, in case that one of members of the first human network does not perform the valuation service, the valuation score of one of members of the first human network is recorded to the lowest value, and as illustrated in FIG. 5, in case that both members do not perform the valuation serve, either the valuation score of one of members of the first human network or one of both members of the first human network is recorded to the lowest value.

In the application server (130), revaluation service is provided so that a member can correct the social capital index of the first human network; the valuation item applet (131) is provided after initializing the individual index and the social capital index, stored in the social network database (120), when the revaluation service is selected; and the valuation score, the individual item index, and the social capital index of the first human network are renewed and stored in the human network database (123) of the social network database (120) after measuring the individual item index and the social capital index of the first human network by using each valuation score, checked by the valuation item applet (131).

Hereinafter, an explanation of the method for measuring social capital index in an online social network according to the present invention will be given with reference to FIGS. 1 to 8.

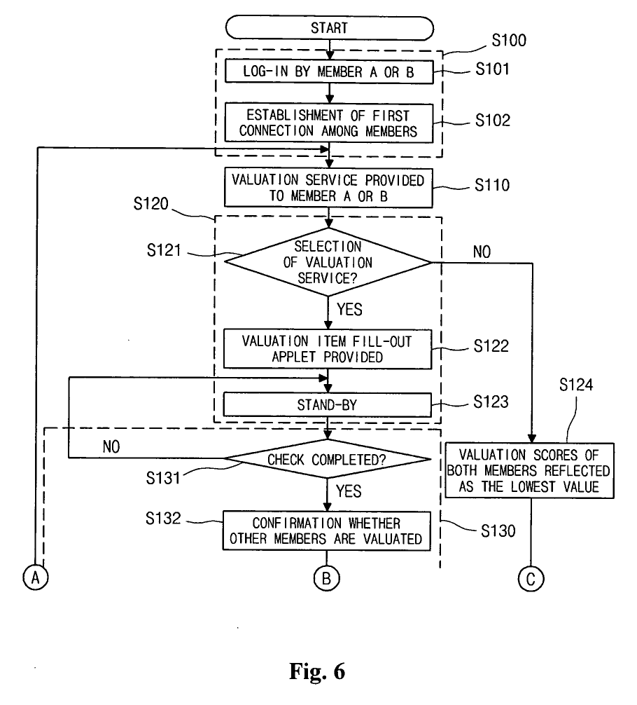

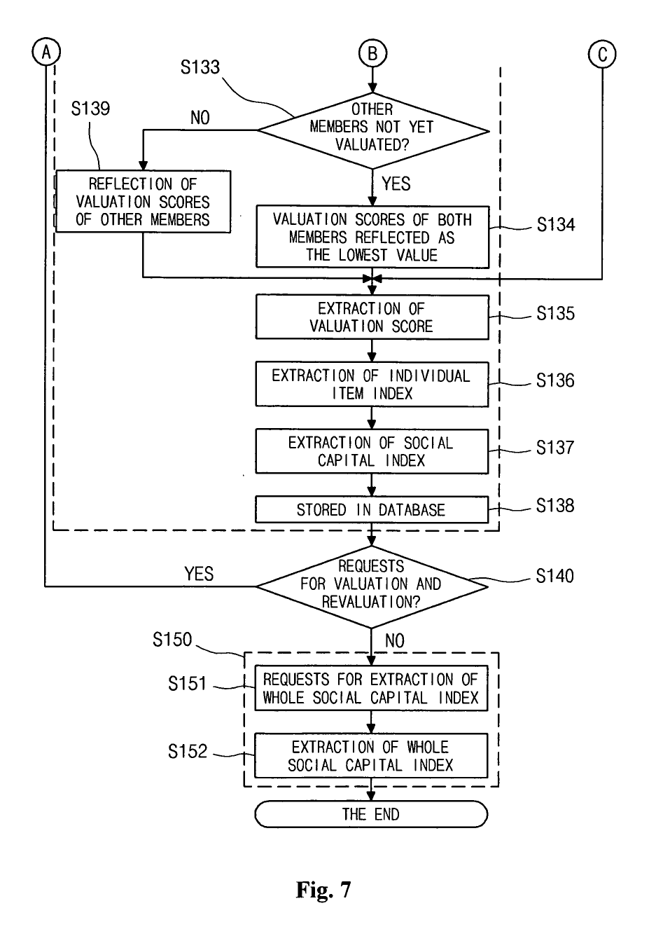

FIGS. 6 and 7 are action flow diagrams for explaining the method for measuring social capital index in the social network according to the present invention; and FIG. 8 is a diagram representing a social network map for explaining the method for measuring social capital index in the social network according to the present invention.

The method for measuring social capital index in an online social network of the present invention is characterized by comprising processes of: establishing first human network (S100) wherein the first human network is established after logging in on the homepage of the application server (130); providing valuation service (S110) wherein the valuation service is provided in order to inter-evaluate the social capital index of the first human network in the application server (130) when the first human network is established; providing applets (S120) wherein the valuation item fill-out applet (131) for measuring the social capital index in the application server (130) to each member of the first human network when the valuation service is selected by members; measuring the social capital index (S130) wherein the individual item index and the social capital index of the first human network are stored in the social network database after measuring the individual item index and the social capital index of the first human network by using each valuation score in the application server (130) when each valuation score is inputted by the valuation item fill-out applet (131); renewing the social capital index (S140) wherein the revaluation service is provided so that a member can correct the social capital index of the first human connection, the valuation item applet (131) is provided when the revaluation service is selected, the individual item index and the social capital index of the first human network are renewed and stored to the human network database (123) of the social network database (120) after measuring the individual item index and the social capital index of the first human network by using each valuation score, checked by the valuation item applet (131); and measuring the whole social capital index (S150) wherein the whole social capital index toward all or partial social connection networks is measured by using the individual item index and the social capital index stored in the human network information database (123) of the social network database (120).

More specifically explaining, a member connects to a homepage throughout the client computer (110) and wire and wireless Internet network, is given with member ID, and stores personal information including ID, name(s), email address(es), telephone number(s), job(s), work area(s), address(es), nation, and school(s) to the member information database (121).

Also, after member A on the homepage of the application server (130) logs in (S101), he/she establishes the first human network with member B (S102). Depending on acceptance of member B or A upon requesting for the first human network of member A or B, the process of establishing the first human network is executed by a common manner which have been used so far.

In such condition, the valuation service is supplied from the application server (130) in order to inter-evaluate the social capital index of the first human relation (S110). At this time, members can choose the valuation service with various methods, for example, the valuation service may be noticed to members by separate windows on the homepage, and popup windows are displayed upon logging in or establishing the first human network among member.

Further, when member A selects the valuation service (S121), the application server (130) is on standby after displaying the valuation item fill-out applet(131) for measuring the social capital index by a type of the graphic user interface (GUI) to the client computer (110) (S122). That is, if member A selects his/her own valuation service after accepting requests for the first human network of member B, the valuation item fill-out applet (131) is displayed to the client computer (110) of member A. At this time, unless both members of the first human network select the valuation service, valuation scores of both members of the first human network in the application server (130) is reflected to the lowest value.

In such condition, when member A checks and completes each valuation score of valuation item (131-1) in which trust index, integrity index, solidarity index, openness index, importance index, and intimacy index are described through check boxes (131 -5)(S 131), whether member B is valuated or not is confirmed in the application server (130) (S132).

Therefore, the valuation of member B is not yet performed (S133), valuation scores are extracted through check locations of each check box (131-5) in the application server (130) (S135) after giving each valuation score of member A and member B in the first human network (S134). At this time, in case that the valuation of member B is completed in the application server (130), it is reflected to the valuation score (S139).

Further, in the application server (130), the extracted valuation score is changed to the individual item index as explained above (S136); the social capital index is measured after giving the individual item index with weight value again (S137); and the social capital index is stored in the human network database (123) of the social network database (120) with member ID as a key (S138).

In such condition, in the application server (130), the revaluation service is provided so that member A or B can correct the social capital index of the first human network; and when the revaluation service is selected (S140), the valuation score, the individual item index, and the social capital index among the first human network are renewed and stored by returning to the step 110(S110) and executing the next processes.

In addition, when requests for measuring the whole social capital index is inputted from a manager in the application server (130) (S151), the whole social capital index toward all or partial social connection networks is measured and provided to the manager by using the individual item index and the social capital index, stored in the human network information database (125) of the social network database (120) (S152).

Sophisticatedly explaining the process of measuring the whole social capital index, member A is in the relation of the first human network with member B and C, and a map is displayed through the social network map as illustrated in FIG. 8 when the social network is constituted while member C is in the relation of the first human network with member D and E.

In such condition, when the manager requests for measuring the whole social capital index of the social network as illustrated in FIG. 8, the individual item index and the social capital index between members of A and B is read from the human network information database (123) of the social network database (120) in the application server (130), and the individual item index and the social capital index between member A and C, C and D, and C and E are read respectively again.

Then, in the application server (130), the average of the grand total, obtained for each individual item index, is measured. Also, the average of the grand total, obtained for each social capital index, is measured and then, the measured value is recorded to the whole social capital index.

The present invention can be variously modified and embodied by several types of forms, and particular illustrative embodiments are merely described in the detailed description of the invention. However, it should be appreciated in such a manner that the present invention is not limited as a particular type, mentioned in the detailed description, but rather it comprises all modified materials, equal materials, and substitutes within the spirit and the range of the present invention, defined by the enclosed claims herewith.

The system and method for measuring social capital index in an online social network according to the present invention is enabled to be used in open markets or online markets like online shopping malls since different kinds of NEEDS can be delivered and solved by using the social capital index with indexing the social capital among members in the social network.

What is claimed is:

1. A system for measuring social capital index in an online social network characterized in comprising: a social network database to which personal information of a member, member ID in the human relation based on the social network, the member ID, and the member ID of the first human connection are stored; and individual item index using each valuation score, inputted through a valuation item fill-out applet, after providing the valuation item fill-out applet for measuring the social capital index with each member of the first human connection when the valuation service is selected and an application server measuring the social capital index among first human connections and storing them in the social network database.

2. The system for measuring social capital index according to claim 1, wherein the social network database is comprised of member information database to which each member's personal information including ID, name(s), email address(es), telephone number(s), job(s), work area(s), address(es), nation, and school(s) is stored; and human network database storing valuation scores, individual item index, and social capital index among the first human relation with member ID as a key while member ID and the member ID of the first human relation are respectively stored in order to check the member ID that is in the first human relation with members on a basis of social network.

3. The system for measuring social capital index according to claim 1, wherein the valuation item fill-out applet is provided as a type of graphic user interface (GUI) in the process of providing the application server.

4. The system for measuring social capital index according to claim 3, wherein each of trust index, integrity index, solidarity index, openness index, importance index, and intimacy index of the valuation item fill-out applet is supplied as valuation items, and a check box is provided in order to record valuation scores, which is upgraded from the lowest value step by step, in each valuation item.

5. The system for measuring social capital index according to claim 4, wherein in the application server, when the valuation score is checked among the first human relation through the valuation item fill-out applet, the valuation score is changed to the individual item index, and the social capital index is measured after giving weight value to the individual item index again.

6. The system for measuring social capital index according to claim 5, wherein the weight value is differently applied depending on trust index, integrity index, solidarity index, openness index, importance index, and intimacy index, and the different applied grand total is 100%.

7. The system for measuring social capital index according to claim 2, wherein the valuation score, the individual item index, and social capital index in the application server is separately stored in the human network information database of the social network database.

8. The system for measuring social capital index according to claim 1, wherein in the application server, in case that one of members, or both members of the first human network does not perform the valuation service, either the valuation score of one of members or one of both members of the first human network is recorded to the lowest value.

9. The system for measuring social capital index according to claim 2, wherein the application server is provided with revaluation service so that a member can correct the social capital index of the first human network; the application service is provided with the valuation item applet when the revaluation service is selected; and the individual item index and the social capital index of the first human network are renewed and stored in human network database of the social network database after measuring the individual item index and the social capital index of the first human network by using each valuation score checked by the valuation item applet.

10. The system for measuring social capital index according to claim 9, wherein in the application server, the whole social capital index toward all or partial social connection networks is measured by using the individual item index and the social capital index stored in the human network information database of the social network database.

11. A method for measuring social capital index in an online social network, the method comprising steps of:
establishing first human network wherein the first human network is established after logging in on the homepage of the application server;
providing valuation service wherein the valuation service is provided in order to inter-evaluate the social capital index of the first human network in the application server when the first human network is established;
providing applets wherein the valuation item fill-out applet for measuring the social capital index in the application server to each member of the first human network when the valuation service is selected by members; and
measuring the social capital index wherein the individual item index and the social capital index of the first human network are stored in the social network database after measuring the individual item index and the social capital index of the first human network by using each valuation score in the application server when each valuation score is inputted by the valuation item fill-out applet.

12. The method for measuring social capital index according to claim 11, wherein the valuation item fill-out applet is provided as a type of graphic user interface (GUI) in the process of providing applets.

13. The method for measuring social capital index according to claim 12, wherein each of trust index, integrity index, solidarity index, openness index, importance index, and intimacy index of the valuation item fill-out applet is supplied as valuation items, and a check box is provided in order to record valuation scores, which is upgraded from the lowest value step by step, in each valuation item.

14. The method for measuring social capital index according to claim 12, wherein in the process of providing applets, when the valuation score is checked among the first human relation through the valuation item fill-out applet, the valuation score is changed to the individual item index, and the social capital index is measured after giving weight value to the individual item index again.

15. The method for measuring social capital index according to claim 13, wherein the weight value is differently applied depending on trust index, integrity index, solidarity index, openness index, importance index, and intimacy index, and the different applied grand total is 100%.

16. The method for measuring social capital index according to claim 11, wherein in the process of measuring the social capital index, in case that one of members, or both members of the first human network does not perform the valuation service, either the valuation score of one of members or one of both members of the first human network is recorded to the lowest value.

17. The method for measuring the social capital index according to claim 11, further comprising the process of renewing the social capital index wherein revaluation service is provided so that a member can correct the social capital index of the first human network, and the individual item index and the social capital index of the first human network are renewed and stored in human network database of the social network database after measuring the individual item index and the social capital index of the first human network by using each valuation score checked by the valuation item applet.

18. The method for measuring the social capital index according to claim 1, further comprising the process of measuring the whole social capital index wherein the whole social capital index toward the whole or partial social connection networks is measured by using the individual item index and the social capital index stored in the human network information database of the social network database.
